(19) United States
(12) Patent Application Publication
(10) Pub. No.: US 2003/0055691 A1
(43) Pub. Date: Mar. 20, 2003

(54) Website and system for delivering human resources information and services

(76) Inventors: David Cooper, Troy, MI (US); W. Jim Fish, Bloomfield Hills, MI (US); Karen Wahl, Newport, MI (US); Mark Koval, Canton, MI (US)

Correspondence Address: BROOKS & KUSHMAN P.C./FGTI, 1000 TOWN CENTER, 22ND FLOOR, SOUTHFIELD, MI, 48075, US

(21) Appl. No.: 09/682,522

(22) Filed: Sep. 14, 2001

(51) Int. Cl. G06F 17/60

(52) U.S. Cl. 705/7

(57) ABSTRACT

A Website and online system for providing human resources information and services. The invention is configured to retrieve a cookie from a client computer in response to the client's HTTP request at the Website wherein the cookie contains an employee identification credential having at least a name and an employment function attribute. The invention is additionally configured to present human resources information and services to the client, at least one of which comprises access to the employee's personal data of record wherein the human resources information and services presented are based on the employee identification credential. The invention is further configured to receive input from the client updating the employee's personal data of record.

### BACKGROUND OF INVENTION

This invention relates generally to the provision of human resources (HR) information and services and, more particularly, to an interactive Website and system for delivering the same.

The provision of HR information and services in today's corporate environments is inefficient. To begin with, corporate employees have no means by which to serve themselves with the valuable HR information and services they often need. For example, an employee interested in learning more about his employer's dress code policy must take valuable time out of his work day to visit the nearest HR department or contact an HR call center. This inefficiency from the employee's perspective is compounded with the non-value-added time the HR staff invests providing employees with the information they are often looking for (HR policies, training programs, schedules and registration, benefits information, etc.). As a result, the HR staff often acts as a go-between, menially relaying static information or services to inquiring employees.

Another problem with the provision of HR information and services in traditional corporate environments is the redundancy, decentralization and misalignment of HR data. Many corporations are nationally or globally based and do not maintain a central, globally-accessible authoritative platform for the provision of HR information and services. As a result, HR data quality is often reduced. Employees and HR agents are often unaware of the extent or availability of HR support outside of their individual locations or departments. Moreover, many global corporations often draft policies in a central office or corporate headquarters hundreds if not thousands of miles away from the employees who are bound by those policies. Consequently, newly enacted policies often take weeks to reach employees. What's more, the many policies received by the employees are often inconsistent in terms of basic form and layout.

Yet another problem with the provision of HR information and services in traditional corporate environments is the inability of an employee to directly access and update their personal information of record (address, phone number, health care dependents, etc.). In today's work environments, employees have no sense of personal data ownership or control. Instead, HR staff plays the role of a go-between menially relaying or updating a current employee's personal information.

Accordingly, a solution is needed for the efficient provision of HR information and services in today's corporate environments. The solution should provide employees with the ability to serve themselves common HR information and services. In doing so, the solution should free up HR staff from the non-value-added task of relaying basic information to inquiring employees. The solution should comprise a central and globally accessible online platform of authoritative HR information, eliminating the redundancy, decentralization and misalignment of HR data across the corporate architecture. Employees should be able to easily and directly access the HR information they need online without having to invest unnecessary effort and time. In addition, employees should be able to directly access and update their personal information of record. What is needed is a Website and system for the provision of HR information and services.

### SUMMARY OF INVENTION

One aspect of the present invention comprises a Website for providing human resources information and services. The Website is configured to retrieve a cookie from a client computer in response to the client's HTTP request at the Website wherein the cookie contains an employee identification credential having at least a name and an employment function attribute.

The Website is additionally configured to present human resources information and services to the client, at least on of which comprises access to the employee's personal data of record wherein the human resources information and services presented are based on the employee identification credential. The Website is further configured to receive input from the client updating the employee's personal data of record.

Another aspect of the present invention comprises a system for providing human resources information and services comprising at least one server computer operably connected to at least one human resources database and serving a human resources Website to a plurality of client computers via a computer network. The at least one server is configured to retrieve a cookie from a client computer in response to the client's HTTP request at the human resources Website wherein the cookie contains an employee identification credential having at least a name and an employment role attribute.

The at least one server is additionally configured to serve human resources information and services to the client, at least one of which comprises access to the employee's personal information of record wherein the human resources information and services presented are based on the employee identification credential. The at least one server is further configured to receive input from the client updating the employee's personal information of record.

### BRIEF DESCRIPTION OF DRAWINGS

FIG. 1 illustrates an introductory Web page at an HR Website in accord with the present invention;

FIG. 2 illustrates a Web page at the HR Website for updating an employee's demographic information of record in accord with the present invention;

FIG. 3 illustrates a Web page at the HR Website for providing an employee manager with access to subordinate employee data in accord with the present invention;

FIG. 4 illustrates a Web page at the HR Website containing a subordinate employee's data in accord with the present invention; and

FIG. 5 illustrates an overview of an online system for implementing the present invention.

### DETAILED DESCRIPTION

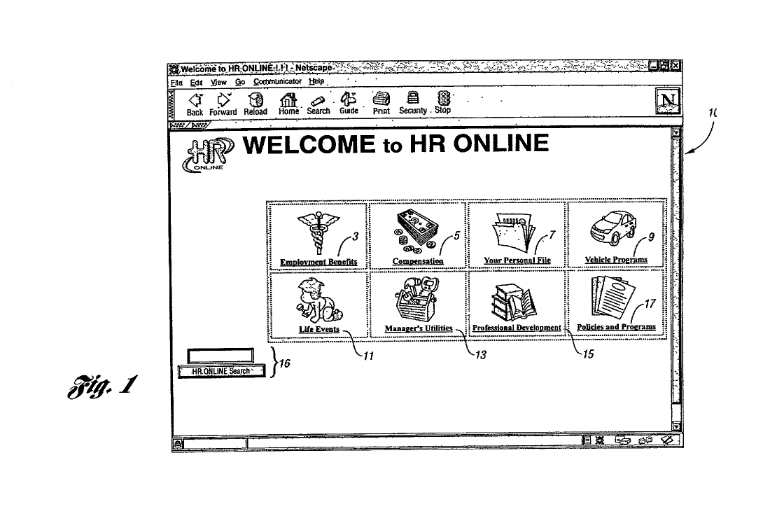

FIG. 1 illustrates an introductory Web page 10 at an HR Website in accord with a preferred embodiment of the present invention. Upon access to the HR Website, client users are required to authenticate themselves. User authentication may be provided by any one of several techniques well-known in the art (i.e., user name and password access control). Preferably, users are authenticated based on a predefined identification credential contained within a browser cookie stored on their respective hard drives. The user identification credential containing a plurality of user attributes including but not limited to the employee's name, employee number, department, employment role, salary, language, and geographic location. Identification credentials are provided to the server hosting the human resources Website for each browsing session upon the users first HTTP request. As discussed in more detail infra, the particular content provided to a user browsing the HR Website is dictated by the particular user attributes contained within the user's identification credential cookie.

The introductory Web page 10 the HR Website provides the user accessing the site with a personalized experience. For example, the user's name 12 (e.g., “Craig McCrary”), extracted from his identification credential, is interactively presented at the introductory page upon access to the Website.

A plurality of hyperlinks 14 are provided for browsing human resources information and utilities provided at the HR Website. Human resources information and utilities provided include, but are not limited to employee benefits 3, compensation 5, the employee's personal information 7, vehicle programs 9, life events 11, professional development 15, and policies and programs 17.

An employee having a managerial employment role attribute contained within his or her identification credential is additionally provided with a hyperlink for browsing managerial utilities 13.

A search field 16 is provided allowing employees with functionality to perform a keyword search of all content presented at the HR online Website.

To browse employment benefits information, a user of the present invention selects the “Employee Benefits” hyperlink 3 and is presented with online access to a plurality of employee benefits information and resources. For example, employees can view static content about company-wide benefit systems and compensation plans. Additionally, employees can perform a retirement earnings estimate. They can access information about their total compensation. Employees can also view their retirement credits and pension balance. Other employment benefits information includes but is not limited to annual reports, health care management, a health care plan decision guide, limitations on SSIP contributions, and a repository of salary bulletins.

To browse compensation information, a user of the present invention selects the “Compensation” hyperlink 5 and is presented with online access to a plurality of employee compensation information and resources. Employee compensation information includes compensation policy and data of record as well as each employee's individual data of record. Preferably, employee salaries are listed according to salary range. Other employee compensation information includes but is not limited to performance bonus plan information, 401 K information, and savings bonds.

To browse a user's personal data of record, a user of the present invention selects the “Your Personal File” hyperlink 7 and is presented with online access to his or her personal data of record.

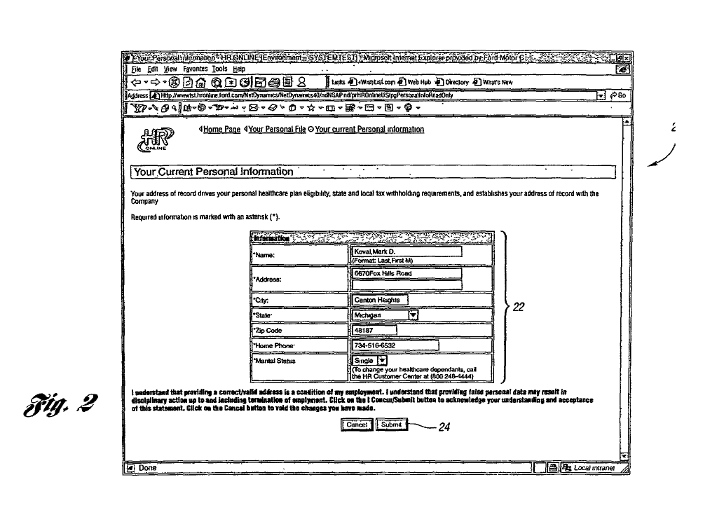

An employee's personal data of record includes but is not limited to the employee's listing information on the corporate directory, the employee's current health care dependents, the employee's current job information, the employee's demographic information, the employee's tax withholdings and the employee's emergency contact information. In accord with a preferred embodiment of the present invention, an employee is provided with an interactive online interface for updating his or her personal data of record. FIG. 2 is a Web page 20 illustrating an interactive interface for updating an employee's demographic information 22. To update the information presented within one or more of the data fields the employee selects the data field to be updated and inputs the corresponding correct information. Once complete, the employee selects the “Submit” button 24 to update a central HR database (not shown) containing the employee's data of record.

Referring again to FIG. 1, a user of the present invention selects the “Vehicle Programs” hyperlink 9 to browse a plurality of employee vehicle program information and resources. Vehicle program information includes, but is not limited to, current model year guidelines, accidents—lease and company cars, break downs/service—lease and company cars, employee resale lot, international vehicle insurance certificates, pool vehicles, QFTF vehicles, quick lease system, rental cars, stolen/vandalized—leased and company cars, vehicle purchase plans, vehicle service centers, and vehicle turn-in process.

To browse life events information and resources, a user of the present invention selects the “Life Events” hyperlink 11. Life events information includes but is not limited to support information for changes in the employee's spouse's employment, divorce, loss of dependent eligibility, marriage, moving/relocation, a new child and retirement planning.

To browse a plurality of managerial information and resources, a user having a managerial attribute contained within his or her access credential, selects the “Manager's Utilities” hyperlink 13. Management information and utilities include, but are not limited to, access to subordinate employee data, employee assessments, administrative functions, hiring information, career transition programs, compensation, on-line job postings, global compensation and benefits, exempt overtime, non-exempt overtime, recognition award program, salaried recruiting, substance abuse, supervisory checklists, and online compensation planning system.

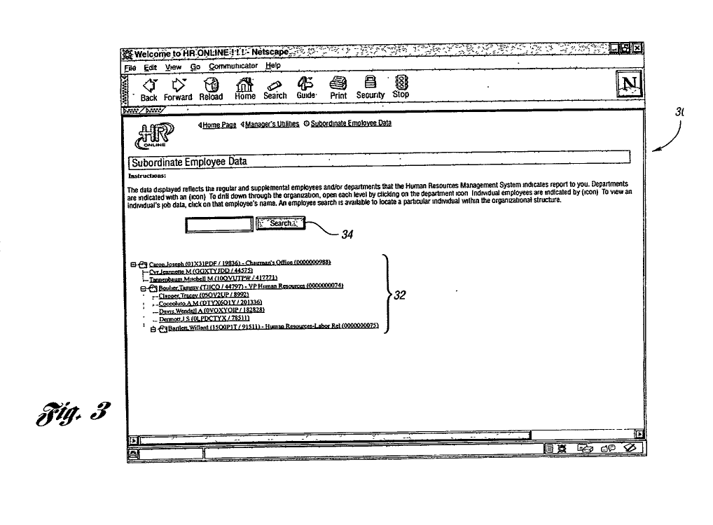

FIG. 3 illustrates a Web page 30 at the HR Website for providing a manager/user with access to subordinate employee data in accord with the present invention. As shown in FIG. 3, employees subordinate to the manager user are presented in a hierarchical format 32. Each subordinate employee listed contains a listing of his or her own subordinate employees. For example, “Tammy Boulier,” vice president of human resources, is subordinate to “Mitchell Tannenbaum.” “Mitchell Tannenbaum,” in turn, is subordinate to “Craig McCrary.” To access detailed employee information of record for any of the listed subordinate employees, the manager/user selects the hyperlink (e.g., “Bartlett, Willard”) corresponding to the employee. Additionally, a search utility 34 is provided for locating a particular employee within a corporate personnel database (not shown).

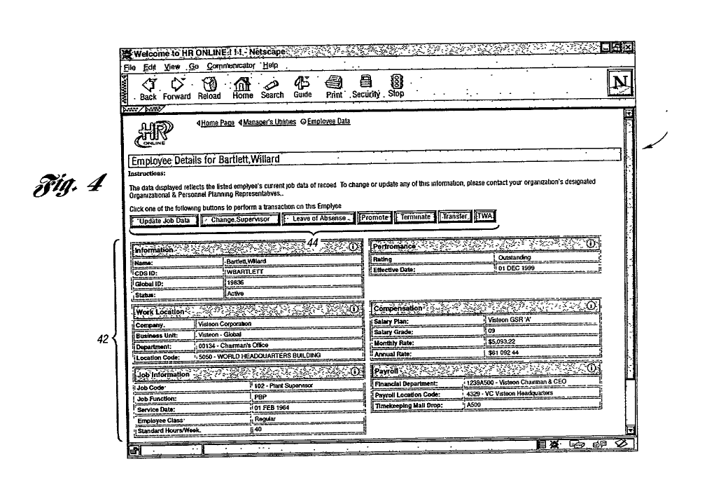

FIG. 4 illustrates a Web page 40 at the HR Website containing a subordinate employee's data in accord with the present invention. The Web page 40 illustrated in FIG. 4 is presented to a manager/user in response to the manager selecting a hyperlink corresponding to a particular subordinate employee (e.g., “Bartlett, Willard”) listed in FIG. 3. Subordinate employee data 42 includes, but is not limited to, the employee's general information (i.e., name, ID, status, etc.), work location (i.e., company, business unit, department, location code, etc.), job information (i.e., job code, job function, service date, employee class, standard hours per week, etc.), performance (i.e., rating, effective date, etc.), compensation (i.e., salary plan, salary grade, monthly rate, annual rate, etc.), and payroll (e.g., financial department, payroll location code, timekeeping mail drop, etc.).

Additionally, a manager can perform a plurality of management transactions 44 on a subordinate employee via the online interface illustrated in FIG. 4. Management transactions include, but are not limited to, updating the employee's job data, changing the employee's supervisor, entering a leave of absence for the employee, promoting the employee, terminating the employee, transferring the employee, and executing a transitional work agreement (TWA) 84.

Referring again to FIG. 1, a user of the present invention selects the “Professional Development” hyperlink 15 to browse a plurality for professional development information and resources. Professional development information includes, but is not limited to, the employee user's leadership assessments, education management, training and development, online employment opportunities, leadership behaviors, leadership development, leadership development centers, and university programs.

To browse online HR policies and programs, a user of the present invention selects the “Policies and Programs” hyperlink 17. HR policy and program information includes, but is not limited to, the Americans With Disabilities Act, anniversary award program, bereavement, blood drive, blood drive scheduling application, child and elder care, diversity, domestic relocation, dress code, employee referrals, equal employment opportunity, harassment, holiday, international service, jobs online, leaves of absence, personal business days, recognition award program, security card access, smoking, telecommunicating, timekeeping, total health, transition work arrangement, vacation, and workplace lactation program. Preferably, human resources policies are presented in a standard format for clarity and organization.

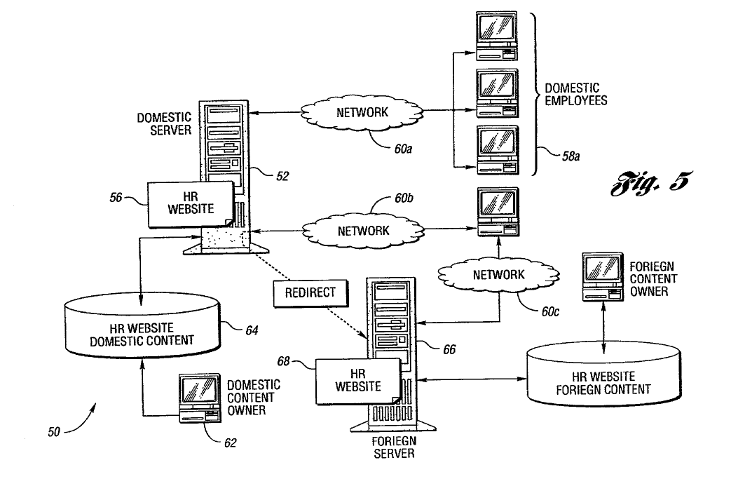

FIG. 5 illustrates a system 50 for implementing the present invention. The system comprises at least one domestic server 52 operably connected to at least one database 54. Additionally, the domestic server 52 is configured to host the HR Website 56 and serve users at a plurality of client computers 58a-58b via a computer network 60a-60c including but not limited to a local area network, a wide area network and the Internet including the World Wide Web.

Domestic content owners 62 upload or store HR content for the HR Website 56 to at least one content database 64 operably connected to the domestic server 52. Via the computer network 60a, domestic employees access the human resources Website 56 using their respective Web browsers operably running on their respective client computers 58a. Domestic employees are presented with Web pages including but not limited to those illustrated and described supra.

Foreign employees whose native language is different from that of the HR Website 56 hosted on the domestic server 52 are redirected upon HTTP request at the domestic server 52 to a foreign server 66 hosting a HR Website 68 having a framework identical to that described and illustrated supra. Content provided on the foreign Website however, is presented in a language consistent with that extracted from the employee's identification credential.

While the best mode for carrying out the invention has been described in detail, those familiar with the art to which this invention relates will recognize various alternative designs and embodiments for practicing the invention as defined by the following claims.

1. A Website for providing human resources information and services, the Website configured to:
retrieve an employee identification credential from a client computer in response to the client's HTTP request at the Website wherein the employee identification credential includes an employee name and an employment function attribute;
present human resources information and services to the client, at least one of which comprises access to the employee's personal data of record wherein the human resources information and services presented are based on the employee identification credential; and
receive input from the client updating the employee's personal data of record.

2. The Website of claim 1 wherein a cookie contains the employee identification credential.

3. The Website of claim 1 wherein the human resources information and services presented additionally comprise employment benefits information and services.

4. The Website of claim 3 wherein one of the employment benefits services comprises an interactive retirement earnings estimation.

5. The Website of claim 3 wherein the employment benefits information comprises the employee's total compensation.

6. The Website of claim 1 wherein the human resources information and services presented additionally comprise employee compensation information of record.

7. The Website of claim 1 wherein the human resources information and services presented additionally comprise vehicle lease and purchase information and services.

8. The Website of claim 1 wherein the vehicle purchase service comprises an interactive vehicle lease and purchase transaction.

9. The Website of claim 1 wherein the human resources information and services presented additionally comprises life events support information.

10. The Website of claim 1 wherein the human resources information and services presented additionally comprises management information and services wherein the management information and services are presented to an employee having an employee identification credential containing a management employment function attribute.

11. The Website of claim 10 wherein the management information comprises employee data for all employees that are subordinate to the manager accessing the Website.

12. The Website claim 11 additionally configured to receive input updating a subordinate employee's job data.

13. The Website of claim 1 wherein the human resources information and services presented additionally comprises professional development information and services.

14. The Website of claim 13 wherein the professional development information comprises employee education and training class information and schedules.

15. The Website of claim 13 wherein the professional development services comprise interactively registering an employee for an employee education or training class.

16. The Website of claim 13 wherein the professional development information comprises an employee's education and training history.

17. The Website of claim 13 additionally configured to present an employee manager with the training history of all the manager's subordinate employees.

18. The Website of claim 1 wherein the human resources information and services presented additionally comprises employment policy and program information.

19. The Website of claim 1 wherein the employee identification credential additionally comprises an employee language attribute and the human resources information and services are presented in the same language as that of the employee language attribute.

20. A system for providing human resources information and services comprising at least one server computer operably connected to at least one human resources database and serving a human resources Website to a plurality of client computers via a computer network, the server configured to:
retrieve an employee identification credential from a client computer in response to the client's HTTP request at the human resources Website wherein the employee identification credential includes an employee name and an employment role attribute;
serve human resources information and services to the client, at least one of which comprises access to the employee's personal information of record wherein the human resources information and services presented are based on the employee identification credential; and
receive input from the client updating the employee's personal information of record.

21. The system of claim 20 wherein a cookie contains the employee identification credential.

22. The system of claim 20 wherein the employee identification credential additionally contains an employee language attribute and the server is additionally configured to redirect the client to a remote server wherein the remote server serves the client human resources information and services in the same language as that identified by the employee language attribute.
